(19) United States
(12) Patent Application Publication
(10) Pub. No.: US 2019/0258766 A1
(43) Pub. Date: Aug. 22, 2019

(54) METHOD AND APPARATUS FOR OBFUSCATING AN INTEGRATED CIRCUIT WITH CAMOUFLAGED GATES AND LOGIC ENCRYPTION

(71) Applicant: INSIDE SECURE, Meyreuil (FR)

(72) Inventors: Bryan J. Wang, South Lake Tahoe, CA (US); Lap Wai Chow, South Pasadena, CA (US); Ronald P. Cocchi, Seal Beach, CA (US); James P. Baukus, Westlake Village, CA (US)

(73) Assignee: INSIDE SECURE, Meyreuil (FR)

(21) Appl. No.: 16/333,589

(22) PCT Filed: Sep. 19, 2017
(86) PCT No.: PCT/US2017/052304

§ 371 Date: Mar. 14, 2019

Related U.S. Application Data
(60) Provisional application No. 62/397,231, filed on Sep. 20, 2016.

(51) Int. Cl. G06F 17/50; H01L 23/00

(52) U.S. Cl. CPC G06F 17/5068; H01L 23/576

(57) ABSTRACT

A method and apparatus for obfuscating at least a portion of an integrated circuit is disclosed. In one embodiment, the method comprises computing a number of observable points (COP) for each net of the portion of the integrated circuit, computing a selection weight (WS) for each net, and selecting one or more nets for insertion of at least one protection element based on the computed selection weights (WS).

### CROSS-REFERENCE TO RELATED APPLICATIONS

This application claims benefit of U.S. Provisional Patent Application No. 62/397,231, entitled “METHOD FOR OBFUSCATING AN INTEGRATED CIRCUIT WITH CAMOUFLAGED GATES AND LOGIC ENCRYPTION,” by Bryan J. Wang, Lap Wai Chow, Ronald P. Cocchi, and James P. Baukus, filed Sep. 20, 2016, which application is hereby incorporated by reference herein.

This application is also related to the following co-pending and commonly assigned patent application(s), all of which applications are incorporated by reference herein:

U.S. patent application Ser. No. 15/675,418, entitled “PHYSICALLY UNCLONABLE CAMOUFLAGE STRUCTURE AND METHODS FOR FABRICATING SAME,” by Ronald P. Cocchi, Lap Wai Chow, James P. Baukus, and Bryan J. Wang, filed Aug. 11, 2017;

which application is a continuation of U.S. patent application Ser. No. 14/985,270, entitled “PHYSICALLY UNCLONABLE CAMOUFLAGE STRUCTURE AND METHODS FOR FABRICATING SAME,” by Ronald P. Cocchi, Lap W. Chow, James P. Baukus, and Bryan J. Wang, filed Dec. 30, 2015, issued Aug. 15, 2017 as U.S. Pat. No. 9,735,781, which application:

Claims benefit of U.S. Provisional Patent Application No. 62/098,108, entitled “METHOD AND APPARATUS FOR BUILDING AN UNCLONABLE ELECTRONICS SYSTEM WITH CIRCUIT CAMOUFLAGE,” by Ronald P. Cocchi, Lap W. Chow, James P. Baukus, and Bryan Wang, filed Dec. 30, 2014, both of which application is hereby incorporated by reference herein.

Is a continuation-in-part of U.S. patent application Ser. No. 13/940,585, entitled “METHOD AND APPARATUS FOR CAMOUFLAGING A STANDARD CELL BASED INTEGRATED CIRCUIT WITH MICRO CIRCUITS AND POST PROCESSING,” by Bryan I. Wang, Lap Wai Chow, James P. Baukus, and Ronald P. Cocchi, filed Jul. 12, 2013, which application is a divisional of U.S. patent application Ser. No. 13/370,118, filed Feb. 9, 2012 and entitled “METHOD AND APPARATUS FOR CAMOUFLAGING A STANDARD CELL BASED INTEGRATED CIRCUIT WITH MICRO CIRCUITS AND POST PROCESSING,” by Ronald P. Cocchi et al. and issued Aug. 13, 2013 as U.S. Pat. No. 8,510,700, which application is:

a continuation-in-part of U.S. patent application Ser. No. 12/380,094, filed Feb. 24, 2009 and entitled “CAMOUFLAGING A STANDARD CELL BASED INTEGRATED CIRCUIT,” by Lap Wai Chow, James P. Baukus, Bryan J. Wang, and Ronald P. Cocchi, issued Apr. 3, 2012 as U.S. Pat. No. 8,151,235; and

a continuation-in-part of U.S. patent application Ser. No. 12/578,441 filed Oct. 13, 2009 entitled “METHOD AND APPARATUS FOR CAMOUFLAGING A STANDARD CELL BASED INTEGRATED CIRCUIT,” by Lap Wai Chow, James P. Baukus, Bryan J. Wang, and Ronald P. Cocchi, issued Apr. 9, 2013 as U.S. Pat. No. 8,418,091, which is a continuation-in-part of U.S. patent application Ser. No. 12/380,094, filed Feb. 24, 2009 and entitled “CAMOUFLAGING A STANDARD CELL BASED INTEGRATED CIRCUIT,” by Lap Wai Chow, James P. Baukus, Bryan J. Wang, and Ronald P. Cocchi, issued Apr. 3, 2012 as U.S. Pat. No 8,151,235;

Is also a continuation-in-part of U.S. patent application Ser. No. 13/789,267, filed Mar. 7, 2013, entitled “METHOD AND APPARATUS FOR CAMOUFLAGING A STANDARD CELL BASED INTEGRATED CIRCUIT,” by Lap Wai Chow, James P. Baukus, Bryan J. Wang, and Ronald P. Cocchi, which application is a continuation of U.S. patent application Ser. No. 12/578,441, filed Oct. 13, 2009, entitled “METHOD AND APPARATUS FOR CAMOUFLAGING A STANDARD CELL BASED INTEGRATED CIRCUIT,” by Lap Wai Chow, James P. Baukus, Bryan J. Wang, and Ronald P. Cocchi and issued Apr. 9, 2013 as U.S. Pat. No. 8,4118,0911, which application is a continuation-in-part of U.S. patent application Ser. No. 12/380,094, filed Feb. 24, 2009, entitled “CAMOUFLAGING A STANDARD CELL BASED INTEGRATED CIRCUIT,” by Lap Wai Chow, James P. Baukus, Bryan J. Wang, and Ronald P. Cocchi, issued Apr. 3, 2012 as U.S. Pat. No. 8,151,235.

### BACKGROUND

### 1. Field

The present disclosure relates to systems and methods for protecting digital circuits, and in particular to a system and method for obfuscating an integrated circuit with camouflaged gates and logic encryption.

### 2. Description of the Related Art

Integrated Circuit (IC) designs are vulnerable to IP theft from reverse engineering, unauthorized cloning and over-production, and device corruption due to Trojan insertion. The risks to the IC industry have been steadily increasing as reverse engineering capabilities increase, and as worldwide IC production capabilities consolidate into a small number of foreign entities.

Logic encryption, also called logic obfuscation, is a hardware obfuscation technique that modifies a circuit so that it operates correctly only when a set of newly-introduced key-data inputs is correctly applied. The key is known only to the original circuit designers and can be programmed into the device's non-volatile storage such as one-time-programmable OTP memory at a secure facility after manufacture. Without the key data, unauthorized devices manufactured by the IC fabricator or by a third party will not function correctly. See, for example, A. Roy, F. Koushanfar, and I. L. Markov, “Ending Piracy of Integrated Circuits,” Design, Automation, and Test in Europe 2008, Munich, Germany, Mar. 10-14, 2008; R. S, Chakraborty and S. Bhunia. “Hardware Protection and Authentication through Netlist Level Obfuscation,” IEEE/ACM International Conference on Computer-Aided Design, 2008; and S. Dupuis, P.-S. Ba, G. Di Natale, M.-L. Flottes, and B. Rouzeyre. “A Novel Hardware Logic Encryption Technique for Thwarting illegal Overproduction and Hardware Trojans,” IEEE International On-Line Testing Symposium, 2014, all hereby incorporated by reference herein.

### SUMMARY

To address the requirements described above, this document discloses a system and method for obfuscating at least a portion of an integrated circuit having a plurality of elements including logic elements and memory elements, the integrated circuit comprising a plurality of nets having two or more interconnected elements. In one embodiment, the method comprises computing a number of observable points (C_{OP}) for each net of the portion of the integrated circuit; compute a selection weight (W_{S}) for each net; and selecting one or more nets for insertion of at least one protection element based on the computed selection weights (W_{S}). Another embodiment is evidenced by an apparatus having a processor and a communicatively coupled memory storing processor instructions for performing the foregoing operations.

In one embodiment, the method is used to choose key-gate locations in a circuit based on its topology. The method balances security concerns and logical effectiveness. When compared to unweighted random selection, this method yields higher efficiency in corrupting device outputs, and reduces the risk of clustering key-gates within a small logical region. The method is heuristic, providing one acceptable solution among many, and an attacker cannot utilize his knowledge of the method to pinpoint the obfuscated key-gates. The key-gate location selection method to be presented works equally well on circuits with or without camouflaged gates, but use of camouflaged gates is highly recommended for the reasons described in the Introduction and Background sections of this document.

In another embodiment, the method is also used to choose insertion points for camouflaged micro-circuits in a circuit based on its topology. The method balances security concerns and logical effectiveness. When compared to unweighted random selection, this method yields higher efficiency in corrupting device outputs, and reduces the risk of clustering camouflaged micro-circuits within a small logical region. The method is heuristic, providing one acceptable solution among many, and an attacker cannot utilize his knowledge of the method to pinpoint the camouflaged micro-circuits.

The features, functions, and advantages that have been discussed can be achieved independently in various embodiments of the present invention or may be combined in vet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram illustrating an overview of logic encryption

FIGS. 2A and 2B are a diagram presenting an illustration of the insertion of key gates into a design to implement logic encryption;

FIGS. 3A and 3B are diagrams illustrating an example of how camouflaged cells can be used to obfuscate a typical logic encryption mechanism

FIG. 4 is a diagram presenting an example of inserting a camouflaged micro-circuit with a stuck-at-zero output to an identified insertion point;

FIG. 5 is a diagram of an exemplary circuit to be protected illustrating launch points and observable points;

FIG. 6 is a diagram presenting an example of conventional circuit with logic encryption using keys K1 and K2 provided to logic gates KG1 and KG2;

FIGS. 7A and 7B are diagrams illustrating a fabricated circuit obfuscated with two key-gates KG1 and KG2 and with camouflaged gates KG1 and G4;

FIG. 8 is a diagram illustrating the value of C_{OP} for each net of the exemplary circuit in FIG. 5;

FIG. 9 is a diagram illustrating an exemplary calculation of selection weights;

FIGS. 10A and 10B are diagram s illustrating two possible selection distributions;

FIGS. 11-13 are diagrams illustrating exemplary operations that can be used to obfuscate an integrated circuit comprising a plurality of interconnected functional logic cells that together perform one or more logical functions; and

FIG. 14 is a diagram illustrating an exemplary computer system 1400 that could be used to implement processing elements of the above disclosure.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

Highly effective protection can be achieved through use of camouflaged gates in conjunction with logic encryption. A camouflaged cell or gate is a logic gate that appears to have one function based on image analysis of the cell layout, but in fact performs a different function. See, for example, L. W. Chow, et al., “Camouflaging a standard cell based integrated circuit,” U.S. Patent Publication No. 2010/0213974, L. W. Chow, et al., “Method and apparatus for camouflaging a standard cell based integrated circuit,” U.S. Patent Publication 2010/0218158, L. W. Chow, et al, “Method and apparatus for camouflaging a standard cell based integrated circuit with micro circuits and post processing,” U.S. Patent Publication 2012/0139582, and L. W. Chow, et al., “Method and apparatus for camouflaging a standard cell based integrated circuit,” U.S. Patent Publication 2013/0191803, all of which are hereby incorporated by reference herein.

Use of camouflaged gates in conjunction with logic encryption protects logic encryption key data against known attacks. Additionally, use of camouflaged gates provides an additional, independent level of security against attackers who are not in possession of the production mask data. If the encryption key is compromised, all camouflaged cells must still be correctly identified and modeled before the circuit can be modeled and duplicated.

### Circuit Camouflage Technology

Circuit camouflage technology encompasses the design and use of camouflaged logic gates whose logical function is difficult to determine using conventional reverse engineering techniques (see U.S. Patent Publications 2010/0213974, 2010/0218158, 2012/0139582, and 2013/0191803, referenced above) The text and diagrams of this invention utilize a style of camouflaged gate whose apparent physical design mimics that of a conventional logic gate of the standard cell library used to design the IC, but the camouflaged gate's actual logic function differs from that of the mimicked logic gates. This is the most prevalent type of camouflaged gate in use today. The camouflaged circuit contains a number of camouflaged gates among a sea of normal gates, and a netlist extracted with conventional reverse engineering techniques will contain a number of discrepancies proportional to the number of camouflaged gates used in the circuit. The number and location of the camouflaged gates is not apparent to the reverse engineer.

### Logic Encryption

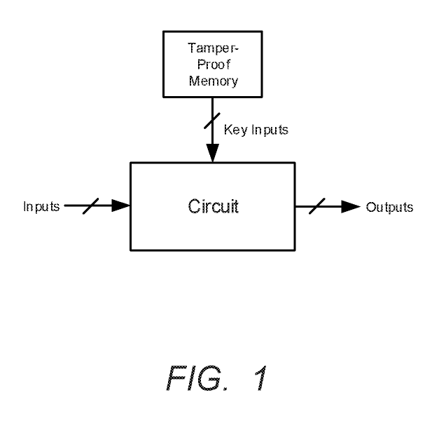

FIG. 1 is a diagram illustrating an overview of logic encryption. Logic encryption introduces a set of key inputs to a circuit. When Key Inputs are set correctly, they will unlock the circuit for correct operation. If one or more bits of key input are incorrect, the circuit's function will be altered and its outputs will be corrupted.

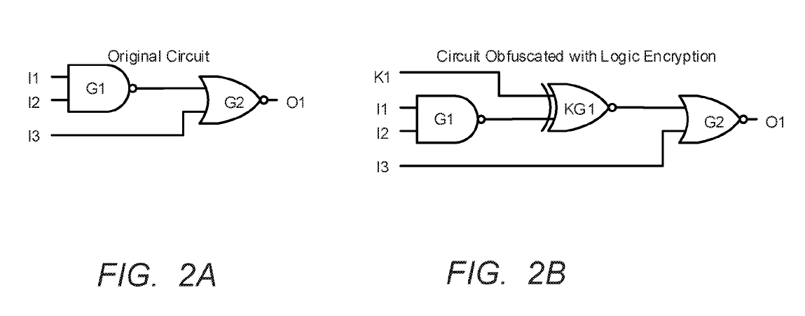

FIGS. 2A and 2B are a diagram presenting an illustration of the insertion of key gates into a design to implement logic encryption. Key gates are inserted into a design to implement logic encryption. A selected set of the circuit's functional signals are gated with the key inputs, or key data at key gates. FIG. 2A presents an example circuit. FIG. 2B presents an illustration of an equivalent of the circuit shown in FIG. 2A obfuscated with the insertion of key gate KG1 and key input K1. This gate-level circuit of FIG. 2B will operate correctly only when key input K1=1.

### Known Security Threats to Conventional Logic Encryption

It has been shown that key data in a conventional logic encryption scheme can be determined from the circuit design in linear time with respect to the key length by applying Input vectors to an unlocked fabricated device, observing device outputs, and using satisfiability checking (SAT) software to infer the logic encryption key from the observations and the gate-level netlist. See, for example, P. Subramanyan, S. Ray, and S. Malik, “Evaluating the Security of Logic Encryption Algorithms,” Hardware-Oriented Security and Trust (HOST), 2015, which is hereby incorporated by reference herein. Conventional logic encryption is also vulnerable to other attack models, as shown in J. Rajendran, Y. Pino, O. Sinanoglu, and R. Karri. “Security Analysis of Logic Obfuscation,” Proceedings of the Design Automation Conference, 2012, also hereby incorporated by reference herein. However, an accurate gate-level netlist of the device is required to perform any attack of this class because the state of a device's internal key-gate nodes must be inferred from its primary outputs. When a number of the device's logic gates are obfuscated with circuit camouflage technology, this type of attack becomes much more difficult because a reverse engineer cannot extract a gate-level netlist whose function matches that of the fabricated device. Therefore, it is highly desirable to utilize camouflaged cells in a logic encryption implementation. Camouflaged gates may be used in the logic encryption network as key-gates, control logic, or glue logic, and they may also be used in the core logic of the fabricated circuit itself.

It has been shown that key data in a conventional logic encryption scheme can be determined from the circuit design in linear time with respect to the key length by applying input vectors to an unlocked fabricated device, observing device outputs, and using satisfiability checking (SAT) software to infer the logic encryption key from the observations and the gate-level netlist (see “Evacuating the Security of Logic Encryption Algorithms” cited above). Conventional logic encryption is also vulnerable to other attack models (see “Security Analysis of Logic Obfuscation” cited above). However, an accurate gate-level netlist of the device is required to perform any attack of this class because the state of a device's internal key-gate nodes must be inferred from its primary outputs. When a number of the device's logic gates are obfuscated with circuit camouflage technology, this type of attack becomes much more difficult because a reverse engineer cannot extract a gate level netlist whose function matches that of the fabricated device. Therefore, it is highly desirable to utilize camouflaged cells in a logic encryption implementation. Camouflaged gates may be used in the logic encryption network as key-gates, control logic, or glue logic, and they may also be used in the core logic of the fabricated circuit itself.

### Key Gate Location Selection

Previous work in the subject of key-gate insertion locations involved maximizing the logical impact of the key-gates without regard for their detectability. Rajendran et al. used fault propagation models to choose key-gate locations that were shown to have the most significant impacts on device outputs (see J. Rajendran, H. Zhang, C. Zhang, G. S. Rose, Y. Pino, O. Sinanoglu, and R. “Fault Analysis-Based Logic Encryption,” IEEE Transactions on Computers vol. 64 (2), pp. 410-424, 2013, hereby incorporated by reference herein). The fault propagation method of logic encryption showed considerable improvements over unweighted random key-gate selection. However, since the entire circuit is comprised of conventional standard cells, the entire circuit may be easily extracted by a reverse engineer, enabling him to find all key-gate locations and to attempt to obtain the secret key-data through circuit analysis and simulation (see “Security Analysis of Logic Obfuscation” cited above). So, while this method may key-gates efficiently to corrupt device outputs, it does not effectively prevent reverse engineering of real circuits. The fault analysis method has several other disadvantages:

1) High tool cost/complexity, as it requires fault propagation and analysis software.

2) Long runtime, as it is an iterative method inserting one key-gate at a time before rerunning fault propagation and analysis.

3) The method yields a unique solution fora given circuit, so awareness of the method will lead an attacker directly to the location of each key-gate.

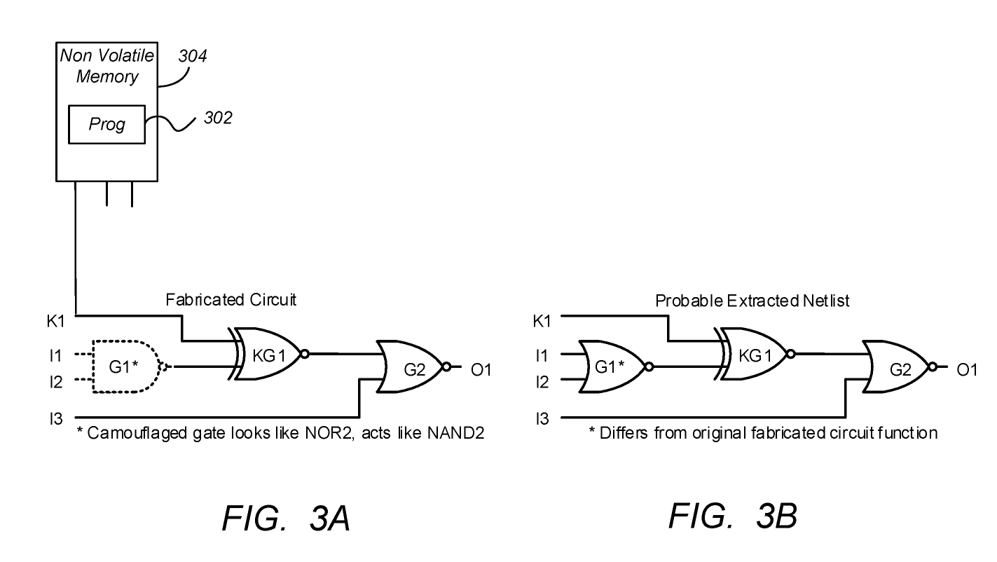

FIGS. 3A and 3B are diagrams illustrating an example of how camouflaged cells can be used to obfuscate a typical logic encryption mechanism. FIG. 3A presents a diagram of an exemplary fabricated circuit with camouflaged gates and logic encryption, and FIG. 3B presents its extracted netlist.

Since gate G1 is a NAND2 gate (camouflaging is indicated by dashed lines) that is camouflaged to looks like a NOR2 gate, it is likely that a reverse engineer will interpret G1 as a NOR2 gate, inferring the incorrect function. With a camouflaged implementation of logic encryption, an attacker cannot use the extracted netlist to determine the key because there is no combination of key inputs that will enable the extracted netlist to behave like the fabricated circuit. Use of camouflaged gates provides an additional level of security. If the encryption key is compromised, all camouflaged cells must be correctly identified and modeled before the circuit will work correctly.

The operations described below and the apparatuses for implementing them enable automated identification of key-gate locations with several advantages over prior methods. In particular:

1) More effective than random selection, circuit topology is considered to determine meaningful locations for key-gates;

2) Avoids clustering key-gates close to each other in the logical network;

3) Heuristic method provides one acceptable solution among many, and an attacker cannot use his knowledge of the method to pinpoint the key-gate locations;

4) Low tool cost, no fault analysis software required;

5) Fast run times, no fault propagation calculations to run.

The described key-gate location selection method works equally well on circuits with or without camouflaged gates, but use of camouflaged gates is highly recommended for the reasons described in the Introduction and Background sections of this document.

### Camouflaged Micro-Circuit Insertion Point Selection

Camouflaged micro-circuits are collections of camouflaged and non-camouflaged gates that perform a logical function, including stuck-at-zero or stuck-at-one (see U.S. Patent Publications 2010/0213974, 2010/0218158, 2012/0139582, and 2013/0191803, referenced above). Because camouflaged gates have a different logical function than their physical design suggests, a camouflaged micro-circuit may perform a different logical function than its physical design suggests. When a reverse engineer attempts to extract a netlist from a device containing one or more camouflaged micro-circuits, it is highly probable the extracted netlist will contain logical errors.

Camouflaged micro-circuits may be inserted, or connected to, logical nodes in the design to provide protection against reverse engineering.

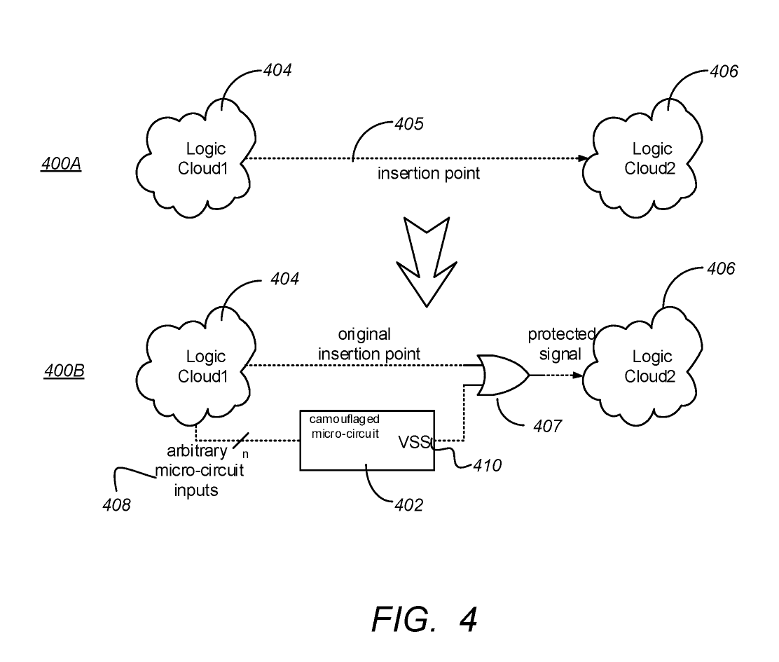

FIG. 4 is a diagram presenting an example of inserting a camouflaged micro-circuit 402 with a stuck-at-zero output to an identified insertion point 404. An uncamouflaged circuit 400A has a first logic cloud 404 having a plurality of logic elements communicatively coupled to a second logic cloud 406 having another plurality of logical elements by a communication path 404 that is an insertion point.

The circuit 400B includes a camouflaged micro circuit 402 and a terminal logic gate 406 interposed at the insertion point. In this illustrated example, the camouflaged micro-circuit 402 has an actual logic function of stuck-at-zero (regardless of input) but its physical design suggests that it has a different function. The circuit 400B fabricated with the camouflaged micro-circuit (bottom) will function identically to the un-camouflaged circuit implementation 400A because a logical zero provided by the camouflaged micro-circuit 402 to one of the inputs to the terminal gate 406 having an OR logical function will assure that the protected signal always has the same logical state as the original insertion point. However, a netlist extracted from the device containing a camouflaged micro-circuit will likely contain errors with conventional reverse engineering methodology.

Other work in the subject of camouflaged micro-circuit insertion point selection was limited to pseudo-random selection based on the logical hierarchy of a circuit. With pseudo-random selection, there is the risk that ineffectual nodes (nodes that are unlikely to affect a circuit's primary outputs) may be chosen as an insertion points.

The techniques presented in this specification enables automated identification of camouflaged micro-circuit insertion points with several advantages over prior methods:

1) More effective than random selection, circuit topology is considered to determine meaningful locations for camouflaged micro-circuits

2) Avoids clustering camouflaged micro-circuits close to each other in the logical network

### Definition of Observable Points and Launch Points

For the purposes of this description, an observable point is the data input of a storage element, or a primary output of the circuit that is to be protected. These points represent logical nodes that are likely to affect primary outputs of the circuit to be protected, either immediately or during a future clock cycle. A launch point is the data output of a storage element, or a primary input of the circuit that is to be protected. These points will define the next state of the circuit.

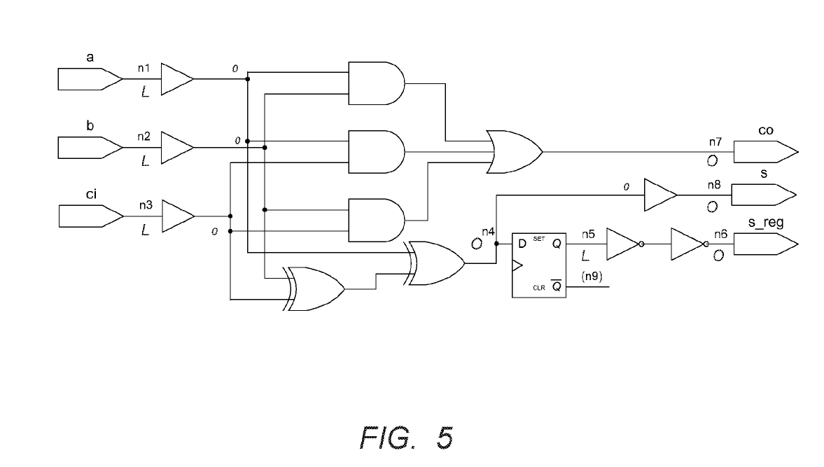

FIG. 5 is a diagram of an exemplary circuit to be protected illustrating launch points (nodes n1, n2, n3, n5) and observable points (nodes n4, n6, n7, n8). As illustrated, observable points are the register inputs (n4) and block primary outputs (n6, n7, and n8). The launch points are the register outputs (n5) and the block primary inputs (n1, n2, and n3). Although n9 is a register output, it is not considered a relevant observable point since it is not connected to any downstream logic. There is nothing in general to preclude a net from being both a launch point and an observable point, although the example does not contain any such nets.

### Hardening Logic Encryption against Key Extraction Attacks

Logic encryption is highly resistant to brute force attack because the key length of a logic encryption implementation can be arbitrarily long. With at 2ⁿ possible key combinations, brute force attack quickly becomes impractical. However, as stated previously, conventional logic encryption has been shown to be weak against a class of attacks that are aimed at inferring the logic encryption key data from an unlocked fabricated device. Once the key data is obtained, the attacker can unlock a locked device, effectively defeating the logic encryption mechanism.

The class of published attacks against logic encryption can be summarized as follows. Note that a gate-level netlist is a necessary component of this class of attack.

1) The attacker obtains two unlocked devices, often purchased on the open market.

2) The attacker extracts the gate-level netlist of the first unlocked device using conventional reverse-engineering techniques.

3) The attacker, using analysis software and the extracted gate-level netlist, develops one or more device input vectors with the goal of determining one or more key bits, which are observable at key-gate input nodes.

4) The attacker applies the input vectors from step 3 to the second unlocked device and observes the device outputs.

5) The attacker, using analysis software and the device's gate-level netlist, attempts to infer one or more key bits using the results obtained in step 4.

6) The attacker repeats step 3-5 until all key bits have been determined.

The use of circuit camouflage technology in the device prevents extraction of an accurate gate-level netlist of the device, This introduces a number of functional discrepancies between the attacker's gate-level netlist and unlocked device, which greatly complicates the attack procedure. The number of functional discrepancies is proportional to the number of camouflaged gates used in the circuit. Since conventional reverse-engineering techniques cannot effectively differentiate a camouflaged gate from a normal gate, the attacker is unable to readily determine either the locations or the number of functional discrepancies. Without an accurate gate-level netlist with which to analyze the device's behavior, it is not possible to determine the key-data from inferring the state of key-gate input nodes.

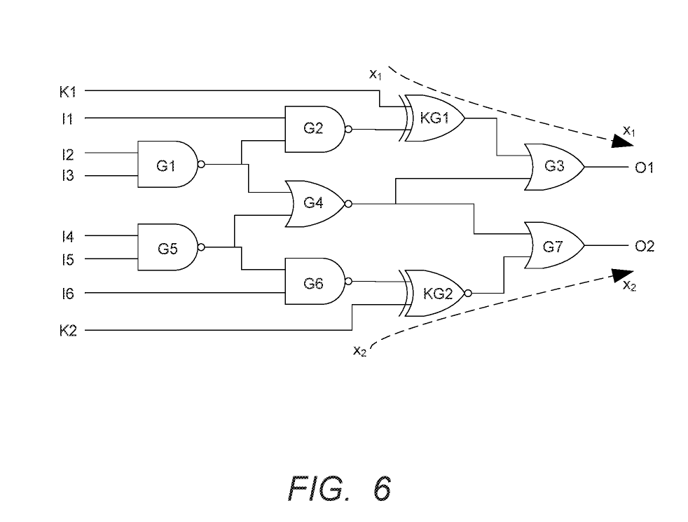

FIG. 6 is a diagram presenting an example of a conventional circuit with logic encryption using keys K1 and K2 provided to logic gates KG1 and KG2. As shown, an attacker extracts a gate-level netlist from a fabricated device. When inputs are applied to the fabricated device and outputs are observed, key data can be inferred through application of Boolean logic on the extracted netlist as shown by Rajendran et al. (e.g. the above-referenced “Security Analysis of Logic Obfuscation”). Hence, key data may be extracted from example circuit obfuscated with two key-gates KG1 and KG2 by applying the input pattern 1000000 to sensitize key bits K1 and K2 to outputs O1 and O2.

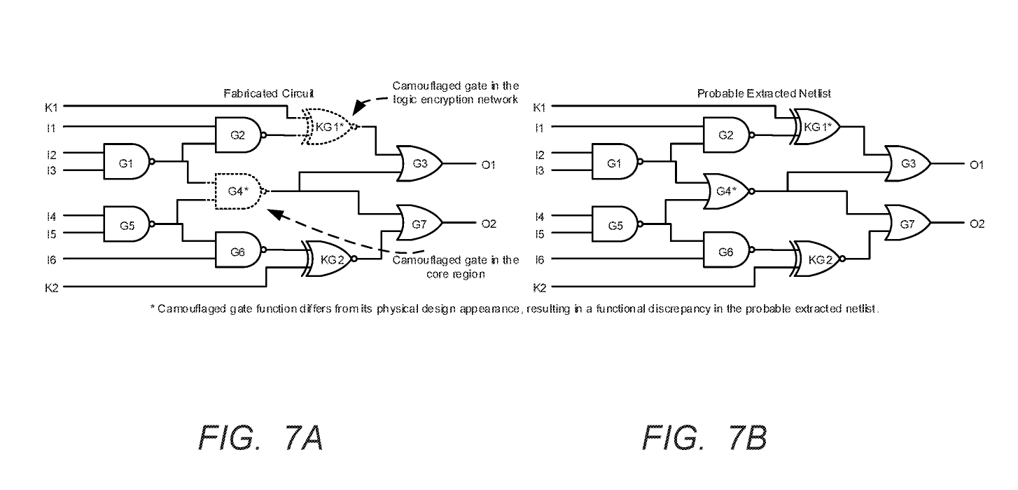

FIGS. 7A and 7B are diagrams illustrating a fabricated circuit obfuscated with two key--gates KG1 and KG2 and with camouflaged gates KG1 and G4. FIG. 7A shows the actual logical function of the fabricated circuit, while FIG. 7B shows its probable extracted netlist. In this example, NAN D gate G4 is camouflaged to appear like a NOR gate, and NOR key-gate KG1 is camouflaged to appear like an OR gate. An attempt to resolve the fabricated circuit's function against the extracted netlist will indicate the presence errors in the extracted netlist that must be corrected. Hence, in the camouflaged circuit with logic encryption, shown in FIG. 7, an attacker extracts an erroneous gate-level netlist from a fabricated device. When inputs are applied to the fabricated device and outputs are observed, functional mismatches between observed and simulated outputs will indicate to the attacker that the extracted netlist is incorrect. Key data cannot be inferred through application of Boolean logic on the erroneous netlist until all netlist errors have been resolved.

### Camouflaged Gates in the Logic Encryption Network

Camouflaged gates may be used effectively in the circuit's logic encryption network. While camouflaged gates in the logic encryption network have no effect on the core functions of the circuit, they prevent an attacker from inferring the logic encryption network's key data through application of Boolean logic on an extracted netlist.

### Camouflaged Gates in the Core Region of the Circuit

Camouflaged gates in the core region of the circuit will cause functional discrepancies between an extracted netlist and the original fabricated circuit even if the correct key-data is applied to the logic encryption network. Additionally, they will prevent an attacker inferring the logic encryption network's key data through application of Boolean logic on an extracted netlist.

### Topological Method for Selecting Protection Element Locations for Logic Encryption

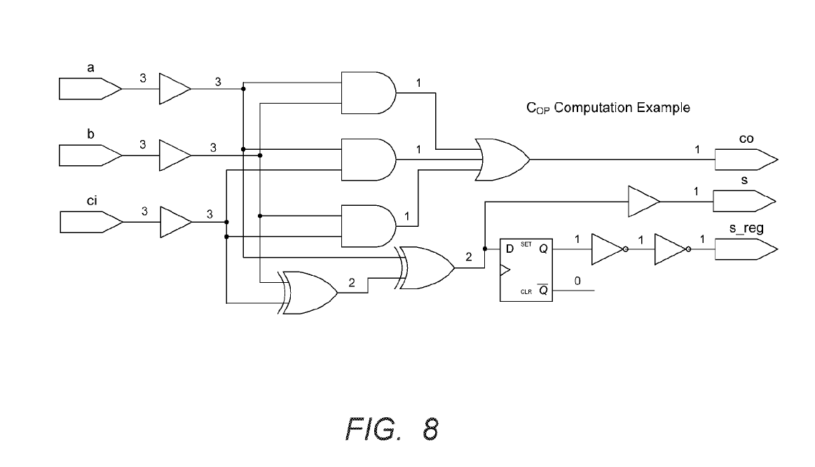

A technique for selecting key-gate locations using circuit topology is now presented. First, the number of observable points (as defined above) are computed for each net. Then, selection weights (W_{S}) for each net are computed, while avoiding launch point bias. Finally, the nets for insertion of protection elements are selected based on selection weights W_{S}. Such protection elements may include key gates and/or camouflaged micro-circuits. The use of key gates as protection elements is described first, then the analogous case of the use of camouflaged micro-circuits is described. These operations are further described below with respect to inserting key gate protection elements with reference the exemplary circuit of FIG. 5, which is reproduced in annotated form in FIG. 8.

### Compute the Number of Observable Points (C_{OP}) for Each Net

This section discusses one embodiment of how to compute the number of C_{OP} for each net. An analysis of circuit topology produces a count of observable points in the downstream logic cone for each net in the circuit that is to be protected. A net whose downstream logic cone connects to a large number of observable points has a high likelihood of corrupting device outputs when incorrect key-data is present. This count, which shall be referred to as C_{OP}, is an integer value that is considered when choosing key-gate locations. The calculation of C_{OP} is the first step in the topological method for selecting key-gate locations. One embodiment of operations that can be used to compute a number of observable points C_{OP} for each net in the circuit to be protected is summarized below. As described above, the launch points of this circuit include points (n1, n2, n3, n5) (which are register outputs (n5) and the block primary inputs (n1, n2, and n3)). Further, the observable points include (n4, n6, n7, n8) (which are register inputs (n4) and block primary outputs (n6, n7, and n8)). FIG. 5 has been annotated to illustrate observable points (O) and launch points (L).

I. Calculate C_{OP} for each net in the circuit to be protected.
a. Initialize an integer C_{OP}=1 for each net that is an observable point, and C_{OP}=0 for each net that is not an observable point.
b. For each net that is an observable point:
   i. Initialize a Boolean value F_{V}=0 for each net in the design to be protected. This value indicates whether or not a net has already been visited for a given observable point.
   ii. Net Driver ID: Identify the net's driver, which is either a launch point or a logic gate output.
   iii. If Driver is a Launch Point (Primary Input or Flip-Flop Output) and F_{V}=0:
      1. Increment C_{OP} and set F_{V}=1.
   iv. If Driver is a Logic Gate and F_{V}=0.
      1. Increment C_{OP} and set F_{V}=1.
   2. Gate Input ID: Identify the nets connected to the logic gate's inputs.
      3. For each net identified in Gate Input ID (Step I.b.iv.2), recursively call Net Driver ID (Step I.b.ii).

FIG. 8 is a diagram illustrating the value of C_{OP} for each net of the exemplary circuit in FIG. 5. The algorithm considers connectivity between gates, but it does not consider the logic function of the gates.

### Compute the Selection Weight (W_{S}) for Each Net to Avoid Launch Point Bias

This section describes on embodiment of how to compute a selection weight (WS) for each net. This selection process avoids launch point bias. It is noted that for nets along any given logic path, C_{OP} of each net increases as its separation from a launch point decreases. This generally leads to a situation where the majority of high C_{OP} values are at or near launch points, and low C_{OP} values are at or near observable points. Therefore, choosing key-gate locations based on C_{OP} alone may have the undesirable effect of reducing an attacker's workload if he infers that a high percentage of key-gates be located at or near launch points. It is desirable to compensate for this launch point bias.

One possible method to compensate for launch point bias is to de-weight nets that are at or very close to launch points, therefore granting highest weights to nets that are neither at the very beginning nor the very end of a logic path. This optimization is desirable to prevent a large number of key-gate locations at the beginning of a logic path, which could become a detectable signature to reverse engineers.

In one implementation, selection weights (W_{S}) are computed by multiplying the previously-computed C_{OP} counts by launch point adjustment factors F_{LPA} that are computed for each net(W_{S}=_{COP}*F_{LPA}). F_{LPA} is a real number between 0 and 1 inclusive, and is computed based on circuit connectivity and two pre-determined constant values, N_{LPA} and N_{L}. N_{LPA} is a real number between 0 and 1 inclusive representing the most significant launch point adjustment factor, which is the factor applied directly to launch points. N_{L} is an integer of at least 1 representing the number of logic levels over which to apply the launch point adjustment factor. The launch point adjustment factor yields the largest adjustment (F_{LPA}=N_{LPA}) when the given net is a launch point, with the factor yielding decreasing adjustments (1>F_{LPA}>N_{LPA}) the further the given net is away from launch points. The factor yields no adjustment (F_{LPA}=1) when the given net is at least N_{L} logic levels away from a launch point. The constants N_{LPA} and N_{L} can either be set by designers or dynamically computed based on analyzing the circuit to be protected. Unless otherwise noted, examples provided in this paper will use the values and N_{LPA}=0.4 and N_{L}=2, which will be acceptable for most circuits.

The following steps show the calculation of launch point adjustment factors (F_{LPA}) and selection weights (W_{S}). They are performed after the previously-described calculation of C_{OP} in Step I.

II. Initialize a launch point adjustment vector V_{LPA} such that it has N_{L} elements and ranges from F_{LPA} to 1−(1−N_{LPA})/F_{L}. This will later be used to convert a net's distance from a launch point to a launch point adjustment factor.
a. Initialize the vector's zero index V_{LPA}[0]=N_{LPA}.
b. If FL=1, then V_{LPA} is complete and go to Step III. If FL>1, set the step size S=(1−N_{LPA})/F_{L}
c. For x=1 to (F_{L}−1), initialize the vector's x index V_{LPA}[x]=V_{LPA}[x−1]+S.

III. Determine each net's distance from a launch point (D_{LP}).
a. Initialize an integer value D_{LP}=MAXINT for each net in the design to be protected. (Nets that are not downstream of any launch point will retain D_{LP}=MAXINT.)
b. For each net that is a launch point:
   i. Initialize a Boolean value F_{V}=0 for each net in the design to be protected. This value indicates whether or not a net has already been visited for a given observable point.
   ii. Call Net Load ID (Step III.b.iii) with parameter D_{CURR}=0.
   iii. Net Load ID: Takes integer parameter D_{CURR} to represent the current distance to the launch point under investigation. Identify the net's downstream loads, which will be an observable point or a logic gate input. Perform Steps iv and v for each load:
   iv. If Load is an Observable Point (Primary Output or Flip-Flop Input) and F_{V}=0:
      1. Set D_{LP}=min(D_{LP}, D_{CURR}) and set F_{V}=1.
   v. If Load is a Logic Gate and _{V}=0:
      1. Set D_{LP}=min(D_{LP}, D_{CURR}) and set F_{V}1.
      2. For each logic gate output pin, identify the net and recursively call Net Load ID (Step III.b.iii), increasing the distance from launch point by 1 by supplying parameter D_{CURR}=D_{CURR}+1.

IV. Calculate selection weight W_{S} for each net by using the net's distance from a launch point to look up F_{LPA} in the launch point adjustment vector V_{LPA}.
a. If D_{LP}>=F_{L} then there is no adjustment factor, so set selection weight W_{S}=C_{OP} and go to Step V. Otherwise go to Look-up Factor from Vector (Step IV.b).
b. Look-up Factor from Vector: Since D_{LP}<F_{L}, set F_{LPA}=V_{LPA}[D_{LP].}
c. Set selection weight W_{S}=C_{OP}*F_{LPA}.

Table 1 below illustrates example launch point adjustment vectors (V_{LPA}) for various values of N_{LPA} and N_{L}. N_{LPA} is a real number between 0 and 1 inclusive, and N_{L} is an integer of at least 1. Grayed boxes indicate that the index is out of bounds.

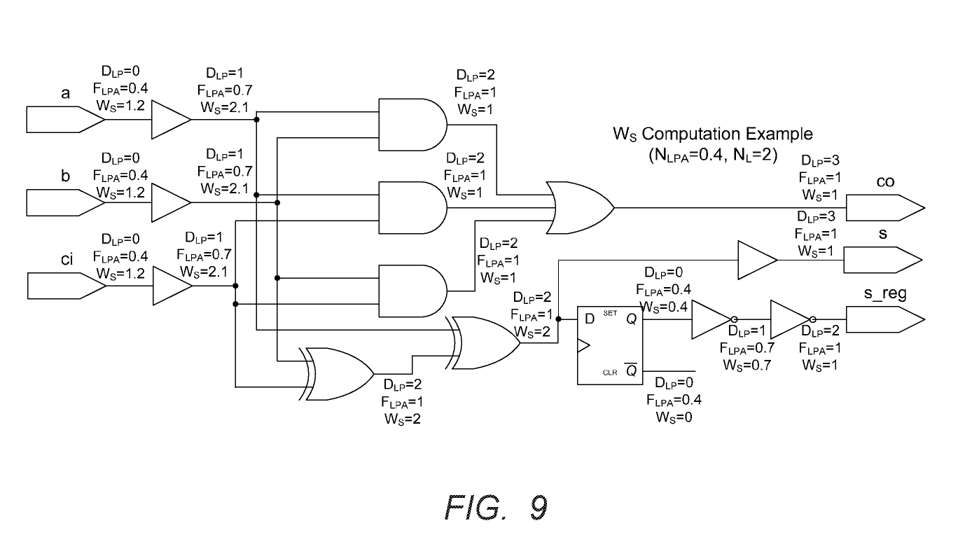

FIG. 9 is a diagram illustrating an exemplary calculation of selection weights (W_{S}) given N_{LPA}=0.4, N_{L}=2, and observable point counts (C_{OP}) calculated as shown in FIG. 8. Intermediate values of distance to launch point (D_{LP}) and launch point adjustment factor (F_{LPA}) are also shown.

### Select the Nets for Key-Gate Insertion Based on Selection Weights (W_{S})

The final step of the key-gate location selection method involves using previously-calculated selection weights (W_{S}) to select the nets for key-gate insertion. The weighted selection algorithm presented below features pseudorandom selection.

It is desirable to avoid a purely deterministic selection process. As an example of an algorithm to avoid, a “greedy” method that selects nets based only on picking the highest selection weights would yield a predictable and repeatable result, and may guide an attacker to discover the key-gate locations. An alternative method is the one described below, which avoids the aforementioned pitfalls.

V. Sort the nets based on ascending selection weights (W_{S}).

VI. Group sorted nets into to N_{B} separate bins B[0] to B[N_{B}−1] such that each bin contains nets with similar selection weights (W_{S}).

VII. Determine the desired number of nets to select from each bin N_{N}[0] to N_{N}[N_{V}−1]. In general, more nets should be chosen from bins with high selection weights than from bins with low selection weights.

VIII. For each bin index (x=0 to x=N_{B}−1), pseudorandomly select N_{N}[x] nets from bin B[x].

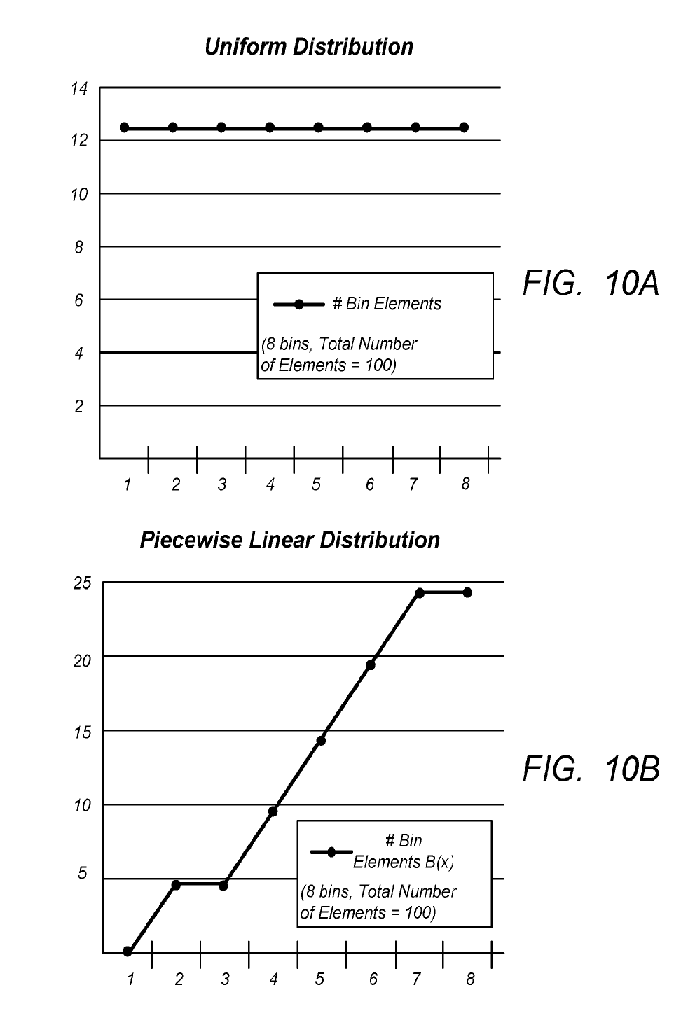

To provide additional explanation for Step VII, two possible selection distributions are illustrated in FIGS. 10A and 10B. A uniform distribution, illustrated in FIG. 10A, approximates unweighted random net selection and is not recommended. A piecewise linear distribution, illustrated in FIG. 10B yields more effective logic encryption because more nets with high selection weights will be chosen. There are many possible selection distributions, and quantitative metrics may be defined to evaluate whether one is more effective than another. A good selection distribution balances the competing objectives of picking the most functionally effective nets se with highest W_{S} values) against making an unpredictable selection.

After completing steps I-VIII as described above, all key-gate locations have been determined. The designer may then proceed with insertion of logic encryption circuitry.

### Topological Method for Selecting Camouflaged Micro-Circuit Insertion Points

The topological method described above that is used to select key-gate locations for logic encryption purposes is also usable to select camouflaged micro-circuit insertion points using circuit topology. The technique fix choosing insertion points for camouflaged micro-circuits is analogous to the technique for choosing key gate insertion points.

### Obfuscating the Integrated Circuit

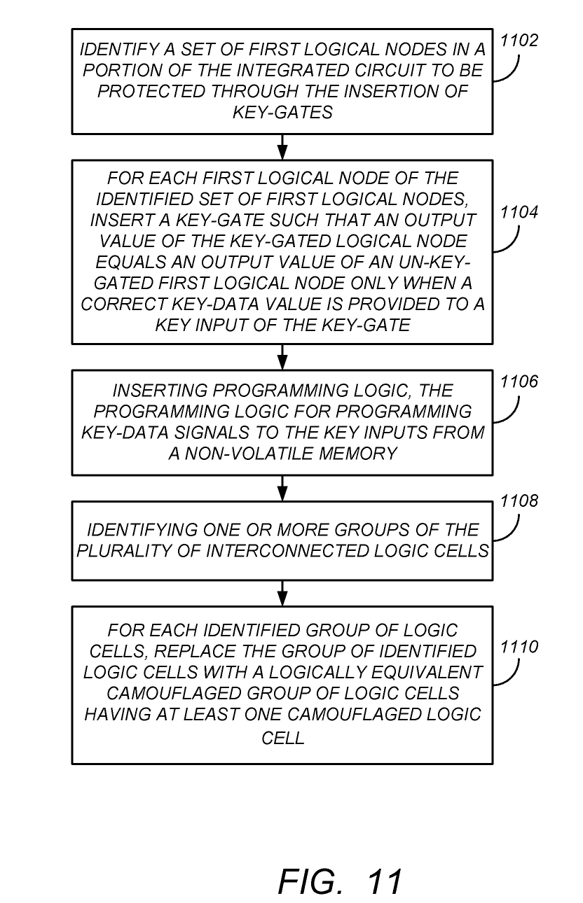

FIGS. 11-13 are diagrams illustrating exemplary operations that can be used to obfuscate an integrated circuit comprising a plurality of interconnected functional logic cells that together perform one or more logical functions. FIGS. 11-13 are discussed below in conjunction with FIG. 4, which illustrates the use of a camouflaged micro circuit 402.

In block 1102, a set of first logical nodes (nodes between interconnected logic or memory elements) in a portion of the integrated circuit to be protected through the insertion of key-gates are identified. These logical nodes are accordingly identified as insertion points. This process can be performed using the techniques described above. In block 1102, for each logical node of the set of logical nodes of the identified first set of logical nodes, a key grate is inserted such that an output value of the key gated first logical node equals an output value of an un-key-gated logical first logical node only when a correct key data value is provided to a key input of the key-gate. An example of this technique is shown in FIG. 3A, in which a key gate KG1 (an NXOR gate) is inserted such that an output value of the key gated first logical node O1 equals an output value of an un-key-gated logical first logical node only when a correct key data value K1=1 is provided to a key input of the key-gate KG1.

Next, programming logic 302 is inserted for programming key data signals to the key inputs from a non-volatile memory 304, as shown in block 1106 and illustrated in FIG. 3A. Next, in block 1108, one or more groups of the plurality of interconnected cells are identified. and in block 1110, the group of identified logic cells are replaced with logically equivalent group of cells having at least one camouflaged logic cell. This is also illustrated, for example, in FIG. 3A where a camouflaged logic call G1 appearing like a NOR gate but having the function of a NAND gate is used.

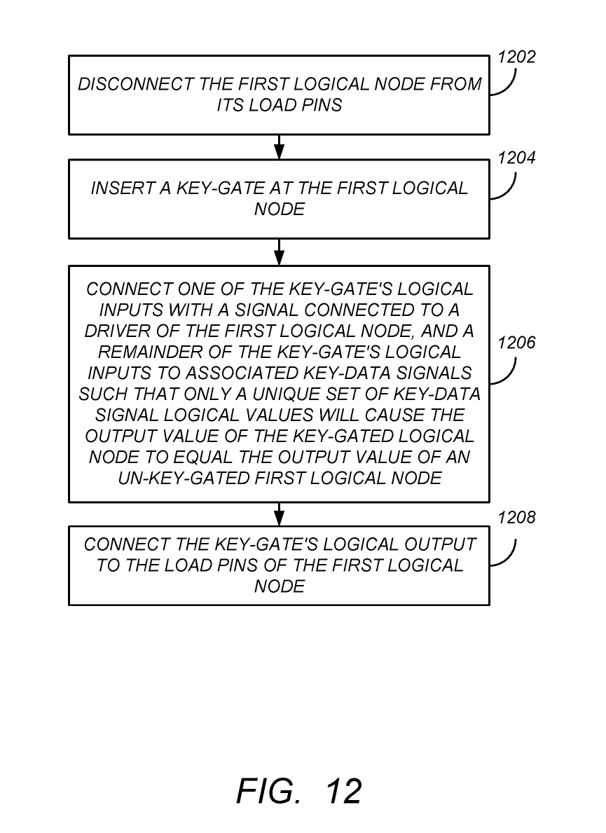

FIG. 12 is a diagram presenting illustrative steps that can be used to insert a key-gate such that an output value of the key-gated logical node equals an output value of an un-key-gated first logical node only when a correct key--data value is provided to a key input of the key-gate.

In block 1202, the first logical node is disconnected from its load pins. For example, referring to FIG. 3A, an original connection between gate G1 and gate G2 is disconnected. In block 1204, a key gate is inserted at the first logical node. Again referring to FIG. 3A, this is illustrated by the insertion of key gate KG1. In block 1206, one of the key gate's logical inputs is connected with a signal connected to a driver of the first logical node, and a remainder of the key gates logical inputs are connected to associated key-data signals such that only a unique set of key-data signal logical values cause the output value c the key-gated logical node to equal the un-key gated first logical node. Again referring to FIG. 3A, this is illustrated by the connection of the lower input of key gate KG1 to the output of gate G1, and the connection of the K1 input to the key gate KG1. Although only one key K1 and key gate KG1 is illustrated, multiple key gates KG and keys key logical values K can be implemented. Finally, in block 1208, the key gate's logical output is connected to the load pins of the first logical node. This is illustrated in FIG. 3A by the connection of the output of key gate KG1 to an input of cute G2.

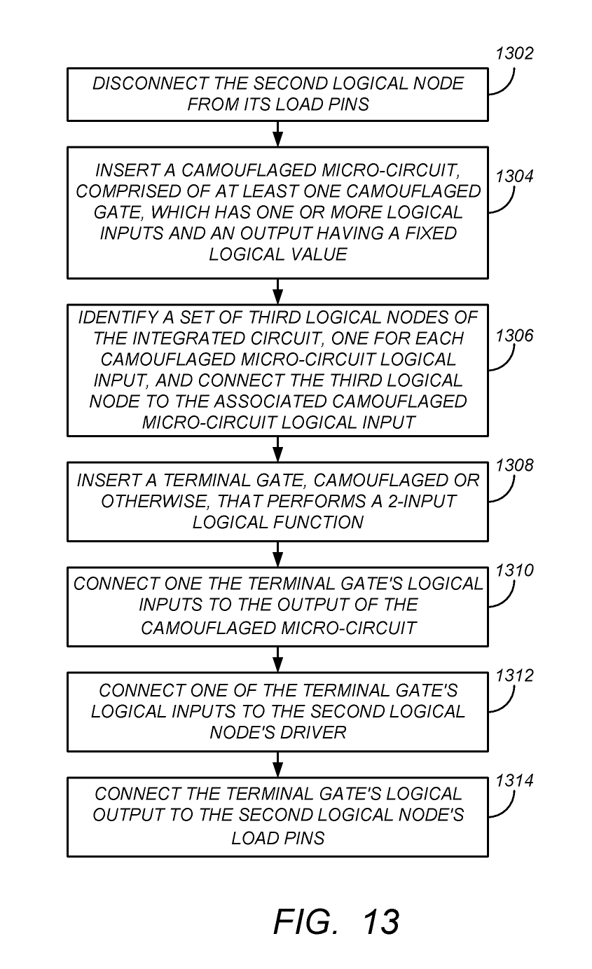

FIG. 13 is a diagram illustrating exemplary method steps for replacing the group of identified logic cells with a logically equivalent camouflaged group of logic cells having at least one camouflaged logic cell. In block 1302, the second logical node is disconnected from its load pins. This is illustrated in FIG. 4, in which the input from the insertion point 404 to Logic Cloud 2 is provided to a logical node within the logic cloud. In block 1304, a camouflaged micro-circuit 402 is inserted, wherein the camouflaged micro-circuit 402 comprises at least one camouflaged gate. The camouflaged micro-circuit 402 comprises one or more logical inputs 408 and a logical output 410 having a fixed logical value. In block 1306, a set of third logical nodes of the integrated circuit are identified, one for each camouflaged micro circuit logical input 410, and these third logical nodes are connected to the associated camouflaged micro circuit logical input 410. In block 1308, a terminal gate 406 that performs a logical function is inserted. In one embodiment, the terminal gate 406 performs a 2-input logical function, but logical functions requiring more inputs are possible. For example, one or more of the terminal gates 406 associated with the camouflaged micro-circuit 402 are combined with one or more adjacent logic gates, resulting in one or more logic gates having three or more inputs.

In block 1310 one of the terminal gates logical inputs are connected to the output 408 of the camouflaged micro circuit 402 (in the embodiment illustrated in FIG. 4, the lower logical input of the terminal gate 406 is so connected). In block 1312, another one of the terminal gates logical inputs are connected to the second logical node's driver, in this case, an element in logic cloud 404 providing the input to the insertion point 404. Finally, in block 1314, the logical output of the terminal gate 406 is connected to the second logical nodes load pins (previously described).

In one embodiment, the camouflaged micro-circuit 402 has an output value having a fixed logical value of zero and the terminal gate 406 performs a logical OR function. In another embodiment, the camouflaged micro-circuit 402 has an output value having a fixed logical value of one and the terminal gate 406 performs an AND function. Other combinations of gates may be used to achieve analogous results.

### Hardware Environment

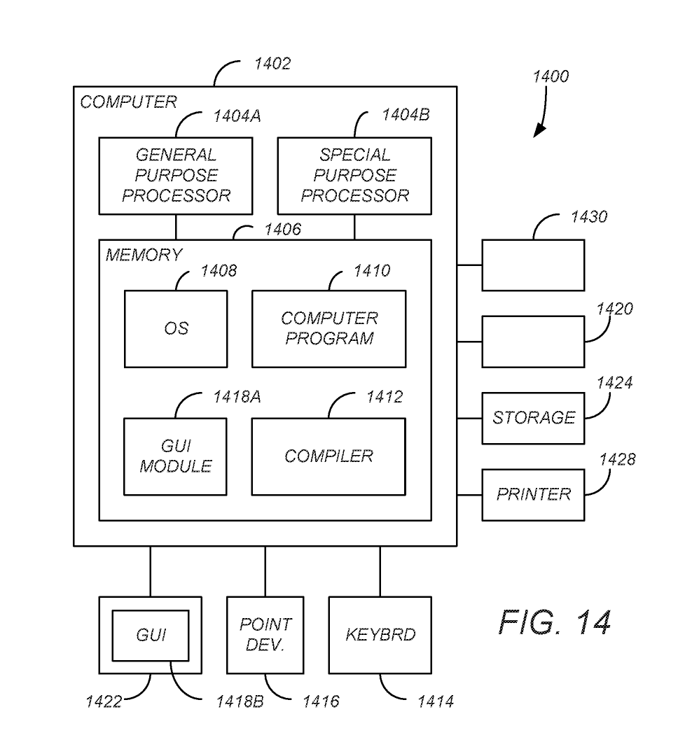

FIG. 14 is a diagram illustrating an exemplary computer system 1400 that could be used to implement processing elements of the above disclosure. The computer 1402 comprises a processor 1404 and a memory, such as random access memory (RAM) 1406. The computer 1402 is operatively coupled to a display 1422, which presents images such as windows to the user on a graphical user interface 1418B. The computer 1402 may be coupled to other devices, such as a keyboard 1414, a mouse device 1416, a printer, etc. Of course, those skilled in the art will recognize that any combination of the above components, or any number of different components, peripherals, and other devices, may be used with the computer 1402.

Generally, the computer 1402 operates under control of an operating system 1408 stored in the memory 1406, and interfaces with the user to accept inputs and commands and to present results through a graphical user interface (GUI) module 1418A. Although the GUI module 1418B is depicted as a separate module, the instructions performing the GUI functions can be resident or distributed in the operating system 1408, the computer program 1410, or implemented with special purpose memory and processors. The computer 1402 also implements a compiler 1412 which allows an application program 1410 written in a programming language such as COBOL, C++, FORTRAN, or other language to be translated into processor 1404 readable code. After completion, the application 1410 accesses and manipulates data stored in the memory 1406 of the computer 1402 using the relationships and logic that was generated using the compiler 1412. The computer 1402 also optionally comprises an external communication device such as a modem, satellite link, Ethernet card, or other device for communicating with other computers.

In one embodiment, instructions implementing the operating system 1408, the computer program 1410, and the compiler 1412 are tangibly embodied in a computer-readable medium, e.g., data storage device 1420, which could include one or more fixed or removable data storage devices, such as a zip drive, floppy disc drive 1424, hard drive, CD-ROM drive, tape drive, etc. Further, the operating system 1408 and the computer program 1410 are comprised of instructions which, when read and executed by the computer 1402, causes the computer 1402 to perform the operations herein described. Computer program 1410 and/or operating instructions may also be tangibly embodied in memory 1406 and/or data communications devices 1430, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### CONCLUSION

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of obfuscating at least a portion of an integrated circuit having a plurality of elements including logic elements and memory elements, the integrated circuit comprising a plurality of nets having two or more interconnected elements, the method comprising:
computing a number of observable points (C_{OP}) for each net of the portion of the integrated circuit;
computing a selection weight (W_{S}) for each net; and
selecting one or more nets for insertion of at least one protection element based on the computed selection weights (W_{S}).

2. The method of claim 1, wherein computing a number of observable points (C_{OP}) for each net of the integrated circuit comprises:
(a) initializing an integer C_{OP}=1 for each net that is an observable point of the integrated circuit and C_{OP}=0 for each net that is not an observable point;
wherein:
an observable point of the integrated circuit consists of a data input of a storage element or a primary output of the portion of the integrated circuit that is to be protected; and
a launch point of the integrated circuit consists of a data output or a storage element or a primary input of the portion of the integrated circuit to that is to be protected;
(b) for each net that is an observable point:
(i) initialize a boolean value F_{V}=0 for each net in the portion of the integrated circuit that is to be protected;
(ii) identifying a driver of the net;
(iii) if the driver is a launch point and F_{V}=0 increment C_{OP} and set F_{V}=1; and
(iv) if the driver is a logic element and F_{V}=0:
increment C_{OP} and set F_{V}=1;
identify nets connected to inputs of the logic element; and
for each identified net, recursively perform (ii)-(iv).

3. The method of claim 1, wherein computing a selection weight for each net comprises:
computing the selection weight W_{S} as a product of previously computed values ox C_{OP} and a launch point adjustment factor F_{LPA}; and
wherein the launch point adjustment factor F_{LPA} has a value between 0 and 1 and is computed based upon connectivity of the portion of the integrated circuit and a most significant launch point adjustment factor N_{LPA} and an integer N_{L} of at least one representing a number of logic levels over which to apply the launch point adjustment factor N_{LPA}.

4. The method of claim 3, wherein N_{L} and N_{LPA} are precomputed.

5. The method of claim 4, wherein computing the selection weight W_{S} as a product of previously computed values of C_{OP} and a launch point adjustment factor F_{LPA} comprises:
initializing a launch point adjustment vector V_{LPA} such that is has N_{L} elements and ranges from F_{LPA} to 1−(1−N_{LPA})/F_{L};
determining a distance D_{LP} of each net from an associated launch point; and
computing the selection weight W_{S} for each net using the distance D_{LP} of each net from its associated launch point, and looking up the launch point adjustment factor F_{LPA} according to the launch point adjustment vector V_{LPA}.

6. The method of claim 5, wherein:
initializing a launch point adjustment vector V_{LPA} such that it has N_{L} elements and ranges from F_{LPA} to 1−(1−N_{LPA})/F_{L} comprises:
initializing an index x of the launch point adjustment V_{LPA} V_{LPA}[x], to a most significant launch point adjustment factor N_{LPA}, wherein the initialized index is a zero index (V_{LPA}[0]=N_{LPA});
determining if F_{L} is greater than one; and
if FL is greater than one, set a step size S=(1−NLPA)/FL, and for x=1 to (FL−1), initialize the index x of the vector V_{LPA}[x] to V_{LPA}[x−1]+S;
determining a distance D_{LP} of each net from an associated launch point comprises:
initialize the distance D_{LP} of each net of the portion of the integrated circuit that is to be protected from an associated launch point to an integer value (MAXINT);
for each net in the portion of the integrated circuit that is to be protected:
initialize a boolean value F_{V}=0 for each net of the portion of the integrated circuit that is to be protected;
identifying a downstream load of each net, wherein the downstream load consists of an observable point or an input to a logic element;
for each identified downstream load:
if the downstream load is an observable point and F_{V}=0, set D_{LP} as a minimum of D_{LP} and D_{CURR} (D_{LP}=min(D_{LP}, D_{CURR})) and set F_{V}=1, wherein D_{CURR} represents a current distance to an associated launch point under examination,
if the downstream load is a logic element and F_{V}=0, set D_{LP} as a minimum of D_{LP} and D_{CURR} (D_{LP}=min (D_{LP}, D_{CURR})) and set F_{V}=1; and
for each logic element output, identify a net associated with the logic element output, set D_{CURR}=D_{CURR}+1;
computing the selection weight W_{S} for each net using the distance D_{LP} of each net from its associated launch point, and looking up the launch point adjustment factor F_{LPA} according to the launch point adjustment vector V_{LPA} comprises:
determining if D_{LP}≥F_{L},; and
if D_{LP}≥F_{L}, setting W_{S}=C_{OP}, otherwise setting WS=C_{OP}*V_{LPA}[D_{LP}].

7. The method of claim 1, wherein selecting one or more nets for insertion based on the computed selection weights (W_{S}) comprises:
sorting the nets based on ascending selection weights (W_{S});
grouping the sorted nets into N_{B} separate bins B[0] to B[N_{B}−1] such that each bin contains nets having selection weights (W_{S}) closer to a selection weight of other nets in the bin than the selection weight (W_{S}) of other nets outside of the bin;
determining a desired number of nets to select from each bin N_{N}[0] to N_{N}[N_{B}−1]; and
for each bin index x having a value from zero to N_{B}−1, pseudorandomly select N_{N}[x] nets from bin B[x].

8. The method of claim 1, wherein the at least a portion of an integrated circuit comprises a key gate portion of the integrated circuit and a functional logic portion or the integrated circuit.

9. A computer-implemented method of obfuscating an integrated circuit (IC), wherein the IC comprises a plurality of interconnected functional logic cells that together perform one or more logical functions, the method comprising the steps of:
identifying a set of first logical nodes in a portion of the integrated circuit to be protected though insertion of key-gates;
for each first logical node of the identified set of first logical nodes, inserting a key-gate such that an output value of the key-gated logical node equals an output value of an un-key-gated first logical node only when a correct key-data value is provided to a key input of the key-gate;
inserting programming logic, the programming logic for programming key-data signals to the key inputs from a non-volatile memory;
identifying one or more groups of the plurality of interconnected logic cells; and
for each identified group of logic cells, replacing the group of identified logic cells with a logically equivalent camouflaged group of logic cells having at least one camouflaged logic cell.

10. The method of claim 9, wherein each logical cell comprises load pins and inserting a key-gate such that an output value of the key-gated logical node equals an output value of an un-key-gated first logical node only when a correct key-data value is provided to a key input of the key-gate comprises:
for each first logical node in the set of first logical nodes:
disconnecting the first logical node from its load pins;
inserting a key-gate at the first logical node;
connect one of the key-gate's logical inputs with a signal connected to a driver of the first logical node, and a remainder of the key-gate's logical inputs to associated key-data signals such that only a unique set of key-data signal logical values cause the output value of the key-gated first logical node to equal the output value of an un-key-gated first logical node;
connecting the key-gate's logical output to the load pins of the first logical node.

11. The method of claim 10, wherein replacing the group of identified logic cells with a logically equivalent camouflaged group of logic cells having at least one camouflaged logic cell comprises:
identifying a set of second logical nodes in the integrated circuit to be protected by utilization of camouflaged micro-circuits; and
for each logical node of the set of second logical nodes:
disconnecting the second logical node from its load pins.
inserting a camouflaged micro-circuit, composed of at least one camouflaged gate, which has one or more logical inputs and an output having a fixed logical value;
identifying a set of third logical nodes of the integrated circuit, one for each camouflaged in circuit logical input, and connect the third logical node to the associated camouflaged micro-circuit logical input;
inserting a terminal gate, camouflaged or otherwise, that performs a 2-input logical function;
connecting one the terminal gate's logical inputs to the output of the camouflaged micro-circuit;
connecting one of the terminal gate's logical inputs to the second logical node's driver; and
connecting the terminal gate's logical output to the second logical node's load pins.

12. The method of claim 11, wherein:
the camouflaged circuit had an output having a fixed logical value of zero; and
the terminal gate performs a logical OR function.

13. The method of claim 11, wherein;
the camouflaged circuit had an output having a fixed logical value of one; and
the terminal gate performs a logical AND function.

14. The method of claim 11, wherein:
one or more of the terminal gates associated with a camouflaged micro-circuit are combined with one or more adjacent logic gates, resulting in one or more complex logic gates with three or more inputs.

15. An apparatus for obfuscating at least a portion of an integrated circuit having a plurality of elements including logic elements and memory elements, the integrated circuit comprising a plurality of nets having two or more interconnected elements, the apparatus comprising:
a processor;
a memory communicatively coupled to the processor, the memory storing instructions comprising instructions for:
computing a number of observable points (C_{OP}) for each net of the portion of the integrated circuit;
computing a selection weight (W_{S}) for each net; and
selecting one or more nets for insertion of at least one protection element based on the computed selection weights (W_{S}).

16. The apparats of claim 15, wherein the instructions for computing a number of observable points (C_{OP}) for each net of the integrated circuit comprise instructions for:
(a) initializing an integer C_{OP}=1 for each net that is an observable point of the integrated circuit and C_{OP}=0 for each net that is not an observable point;
wherein:
an observable point of the integrated circuit: consists of a data input of a storage element or a primary output of the portion of the integrated circuit that is to be protected; and
a launch point of the integrated circuit consists of a data output of a storage element or a primary input of the portion of the integrated circuit to that is to be protected;
(b) for each net that is an observable point:
(i) initialize a boolean value F_{V}=0 for each net in the portion of the integrated circuit that is to be protected;
(ii) identifying a driver of the net;
(iii) if the driver is a launch point and F_{V}=0, increment C_{OP} and set F_{V}=1; and
(iv) if the driver is a logic element and F_{V}=0;
increment C_{OP} and set F_{V}=1;
identity nets connected to inputs of the logic element; and
for each identified net, recursively perform (ii)-(iv).

17. The apparatus of claim 15, wherein the instructions for computing a selection weight for each net comprise instructions for:
computing the selection weight W_{S} as a product of previously computed values of C_{OP} and a launch point adjustment factor F_{LPA}; and
wherein the launch point adjustment factor F_{LPA} has a value between 0 and 1 and is computed based upon connectivity of the portion of the integrated circuit and a most significant launch point adjustment factor N_{LPA} and an integer N_{L} of at least one representing a number of logic levels over which to apply the launch point adjustment factor N_{LPA}.

18. The apparatus of claim 17, wherein N_{L} and N_{LPA} are precomputed.

19. The apparatus of claim 18, wherein computing the selection weight W_{S} as a product of previously computed values of C_{OP} and a launch point adjustment factor F_{LPA} comprises:
initializing a launch point adjustment vector V_{LPA} such that it has N_{L} elements and ranges from F_{LPA} to 1−(1−N_{LPA})/F_{L};
determine a distance D_{LP} of each net from an associated launch point; and
computing the selection weight W_{S} for each net using the distance D_{LP} of each net from its associated launch point, and looking up the launch point adjustment factor F_{LPA} according to the launch point adjustment vector V_{LPA}.

20. The apparatus of claim 19, wherein:
the instructions for initializing a launch point adjustment vector V_{LPA} such that it has N_{L} elements and ranges from F_{LPA} to 1−(1−N_{LPA})/F_{L} comprise instructions for:
initializing, an index x of the launch point adjustment vector V_{LPA} V_{LPA}[x], to a most significant launch point adjustment factor N_{LPA}, wherein the initialized index is a zero index (V_{LPA}[0]=N_{LPA});
determining if F_{L} is greater than one; and
if FL is greater than one, set a step size S=(1−NLPA)/FL, and for x=1 to (FL−1), initialize the index x of the vector V_{LPA}[x] to V_{LPA}[x]+S;
the instructions for determining a distance D_{LP} of each net from an associated launch point comprise instructions for:
initialize the distance D_{LP} of each net of the portion of the integrated circuit that is to be protected from an associated launch point to an integer value MAXINT);
for each net in the portion of the integrated circuit is to be protected:
initialize a boolean value F_{V}=0 for each net of the portion of the integrated circuit that is to be protected;
identifying a downstream load of each net, wherein the downstream load consists of an observable point or an input to a logic element;
for each identified downstream load:
if the downstream load is an observable point and F_{V}=0 set D_{LP} as a minimum of D_{LP} and D_{CURR} (D_{LP}=min(D_{LP}, D_{CURR})) and set F_{V}=1, wherein D_{CURR} represents a current distance to an associated launch point under examination;
if the downstream load is a logic element and F_{V}=0, set D_{LP} as a minimum of D_{LP} and D_{CURR} (D_{LP}=min(D_{LP}, D_{CURR})) and set F_{V}=1; and
for each logic element output, identify a net associated with the logic element output, set D_{CURR}=D_{CURR}+1;
the instructions for computing the selection weight W_{S} for each net using the distance D_{LP} of each net from its associated launch point, and looking up the launch point adjustment factor F_{LPA} according to the launch point adjustment vector V_{LPA} comprise instructions for:
determining if D_{LP}≥F_{L},; and
if D_{LP}≥F_{L}, setting W_{S}=C_{OP}, otherwise setting WS=C_{OP}*V_{LPA}[D_{LP}].
